(19) United States
(12) Patent Application Publication
(10) Pub. No.: US 2004/0101143 A1
(43) Pub. Date: May 27, 2004

(54) Method and system for digitally decoding an MTS signal

(75) Inventors: Sealtiel Avalos, Dallas, TX (US); Robert D. Kaylor, Rowlett, TX (US); Robert Kessler, Dallas, TX (US); Randall J. Muncy, Wylie, TX (US)

Correspondence Address: HAYNES AND BOONE, LLP, 901 MAIN STREET, SUITE 3100, DALLAS, TX, 75202, US

(73) Assignee: Cable Electronics, Inc., Garland, TX

(21) Appl. No.: 10/717,593

(22) Filed: Nov. 19, 2003

Related U.S. Application Data
(60) Provisional application No. 60/427,473, filed on Nov. 19, 2002.

(51) Int. Cl. H04H 5/00

(52) U.S. Cl. 381/2; 381/16

(57) ABSTRACT

A method and system is disclosed for digitally demodulating an analog signal. In one example, the analog signal contains a L+R signal, a L−R signal centered around a carrier signal, and a pilot signal. An exemplary system for digitally demodulating such a signal includes an analog to digital converter, three digital filters, clock reconstitution circuitry, L−R signal recovery circuitry, and channel recovery circuitry. The analog to digital converter converts the analog signal into a digital signal. The three filters separate the L+R signal, the pilot signal, and the L−R signal from the digital signal. The clock reconstitution circuitry reconstitutes a clock signal from the separated pilot signal. The L−R signal recovery circuitry recovers the separated L−R signal using the reconstituted clock signal. The channel recovery circuitry recovers a left channel signal and a right channel signal from the separated L+R signal and the recovered L−R signal.

### CROSS-REFERENCE

The present application claims priority to U.S. Provisional Patent Application Ser. No. 60/427,473, filed on Nov. 19, 2002.

### BRIEF DESCRIPTION OF THE DRAWINGS

FIG. 1 illustrates a block diagram of one embodiment of a digital decoding system.

FIG. 2 illustrates a signal that may be decoded using the digital decoding system of FIG. 1.

FIG. 3 illustrates a block diagram of another embodiment of a digital decoding system that may be used to decode the signal of FIG. 2.

FIG. 4 illustrates a block diagram of clock reconstitution circuitry that may be used within the digital decoding system of FIG. 3.

FIG. 5 illustrates a block diagram of L−R signal recovery circuitry that may be used within the digital decoding system of FIG. 3.

FIG. 6 is a flow chart of an exemplary method for using the digital decoding system of FIG. 3 to demodulate the signal of FIG. 2.

### WRITTEN DESCRIPTION

The present disclosure relates generally to audio decoding and, more particularly, to a method and system for digitally decoding audio signals. It is understood, however, that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not, in itself, dictate a relationship between the various embodiments and/or configurations discussed.

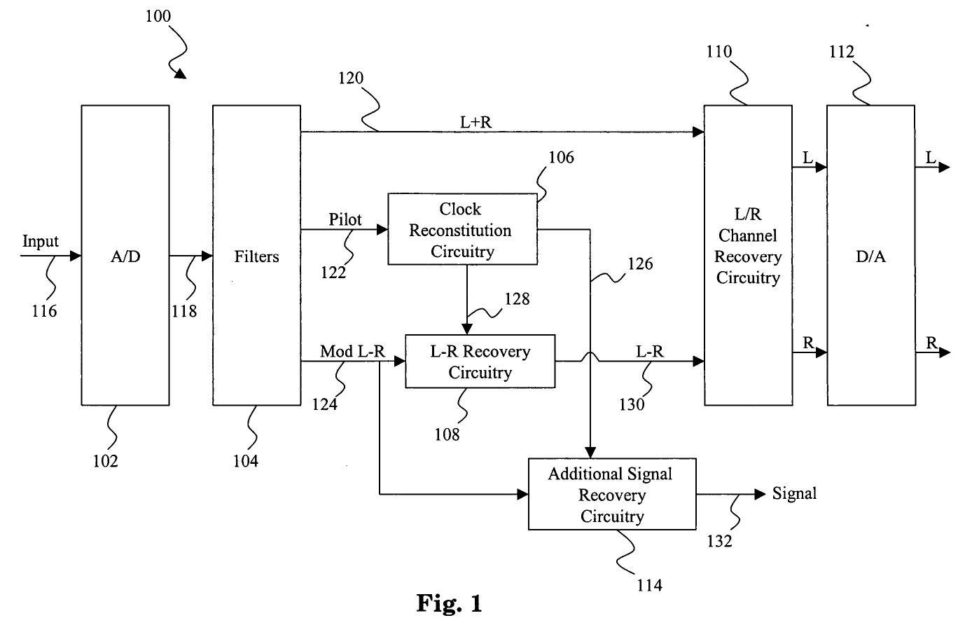

Referring to FIG. 1, in one embodiment, an exemplary digital decoder system 100 is illustrated for digitally extracting left (L) and right (R) channel information from an analog signal. The system 100 includes an analog to digital (A/D) converter 102, multiple digital filters 104, clock reconstitution circuitry 106, L−R signal recovery circuitry 108, L/R channel recovery circuitry 110, a D/A converter 112, and additional signal recovery circuitry 114. The additional signal recovery circuitry 114 is representative of circuitry that may be used to extract signal information other than the L and R channel information from the analog signal. For example, the additional signal recovery circuitry 114 may be used to extract a second audio program (SAP) signal.

In operation, as will be described later in greater detail, the A/D converter 102 receives an encoded (e.g., modulated) analog signal 116 from a single analog channel. The A/D converter 102 converts the analog signal 116 to a digital signal 118, and passes the digital signal to multiple filters 104. The filters 104 separate the digital signal 118 into an L+R signal 120, a pilot signal 122, and a modulated L−R signal 124. The L+R signal 120 is passed into the L/R channel recovery circuitry 110. The pilot signal 122 is passed into the clock reconstitution circuitry 106, which feeds a first reconstituted clock signal 126 to the additional signal recovery circuitry 114 and a second reconstituted clock signal 128 to the L−R signal recovery circuitry 108 (although the first and second signals may be the same signal).

The modulated L−R signal 124 is passed into the L−R signal recovery circuitry 108 and the additional signal recovery circuitry 114. The L−R signal recovery circuitry 108 recovers the L−R signal using the reconstituted clock signal 128 and passes the L−R signal to the L/R channel recovery circuitry 110 (e.g., a demultiplexing matrix). The L/R channel recovery circuitry 110 isolates the L and R channel signals and passes them to the D/A decoder 112, which converts the L and R channel signals to analog and outputs them to an external device, such as a television (not shown). The additional signal recovery circuitry 114 uses the modulated L−R signal 124 and the reconstituted clock signal 126 to reform a secondary signal (e.g., a SAP signal) for output.

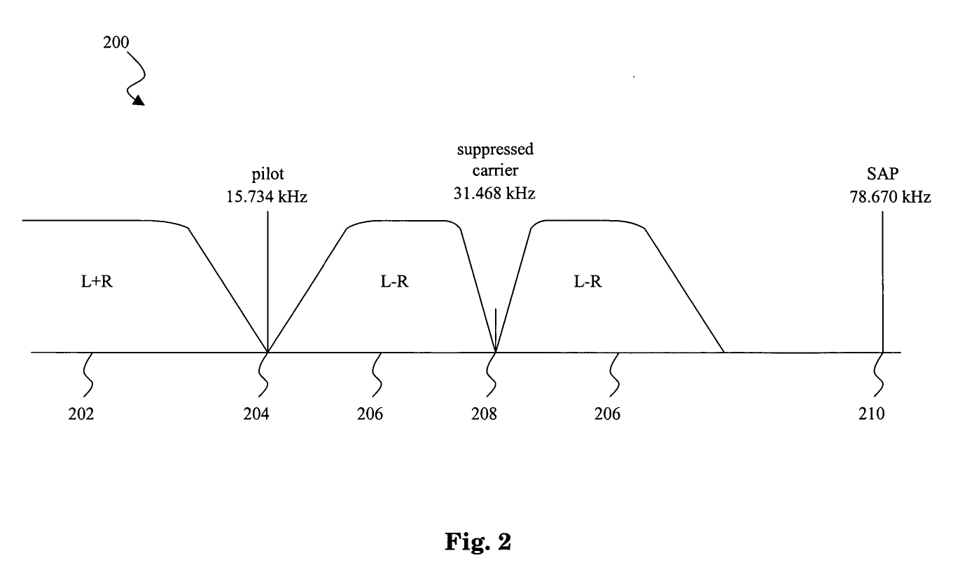

Referring now to FIG. 2, an exemplary analog signal 200 is illustrated with multiple signal components (not to scale) including a L+R signal 202, a pilot signal 204, a double sideband L−R signal 206 centered around a suppressed carrier signal 208, and an additional signal 210, such as a SAP signal. It is understood that the SAP signal 210 may be a double sideband signal, but is shown only as a single frequency spectral line for purposes of convenience. In the present embodiment, the analog signal 200 may include audio information formatted in accordance with the multichannel television sound (or “MTS”) standard. The MTS standard governs the transmission of audio information to televisions. In accordance with this standard, audio information is carried in two signals, the L+R signal 202 and the L−R signal 206. The L−R signal 206, which represents the difference between left and right channels, carries stereo information within a first frequency band and surround sound information within a second, higher, frequency band.

During modulation, the pilot signal 204 and the carrier signal 208 may be digitally generated and locked to the horizontal rate (H) of an incoming video signal. The process used for detecting and holding the lock is biased away from the vertical blanking interval. There are many pulses in this interval that could be construed as horizontal sync signals, but in reality are serration pulses or signals from an anti-taping protocol. This process provides a stable lock that is not subject to phantom signals. The carrier is a digitized sine wave at twice the horizontal rate (2H) and is locked to the horizontal sync rate of the incoming video signal. The modulated signal is summed with the pilot signal. The pilot is a digitized sine wave at the horizontal rate H and is phase locked to carrier frequency. This is used during demodulation of the L−R signal 206 as described below in greater detail.

In the present example, the pilot signal 204 is a 1H reference that is a single frequency spectral line at 15.734 kHz. The L−R signal 206 is centered at 2H (e.g., 31.468 kHz) and the SAP signal 210 is centered at 5H (e.g., 78.670 kHz). More specifically, the L+R signal 202 occupies the spectrum from 10 Hz to 14 kHz; the double sideband suppressed carrier (DSBSC) L−R signal 206 is centered at 31.468 kHz with modulation of +−14 kHz; and the DSBSC SAP signal 210 is centered at 78.670 kHz with modulation of +−10 kHz.

The analog signal may be encoded as described in U.S. Pat. No. 5,953,067, filed on Aug. 25, 1997, and entitled “MULTICHANNEL TELEVISION SOUND STEREO AND SURROUND SOUND ENCODER,” U.S. Pat. No. 6,288,747, filed on Sep. 9, 1998, and entitled “MULTICHANNEL TELEVISION SOUND STEREO AND SURROUND SOUND ENCODER SUITABLE FOR USE WITH VIDEO SIGNALS ENCODED IN PLURAL FORMATS,” or U.S. Pat. No. 6,445,422, filed on Jul. 25, 2001, and entitled “MULTICHANNEL TELEVISION SOUND STEREO AND SURROUND SOUND ENCODER SUITABLE FOR USE WITH VIDEO SIGNALS ENCODED IN PLURAL FORMATS,” all of which are assigned to the assignee of the present disclosure and hereby incorporated by reference as if reproduced in their entirety.

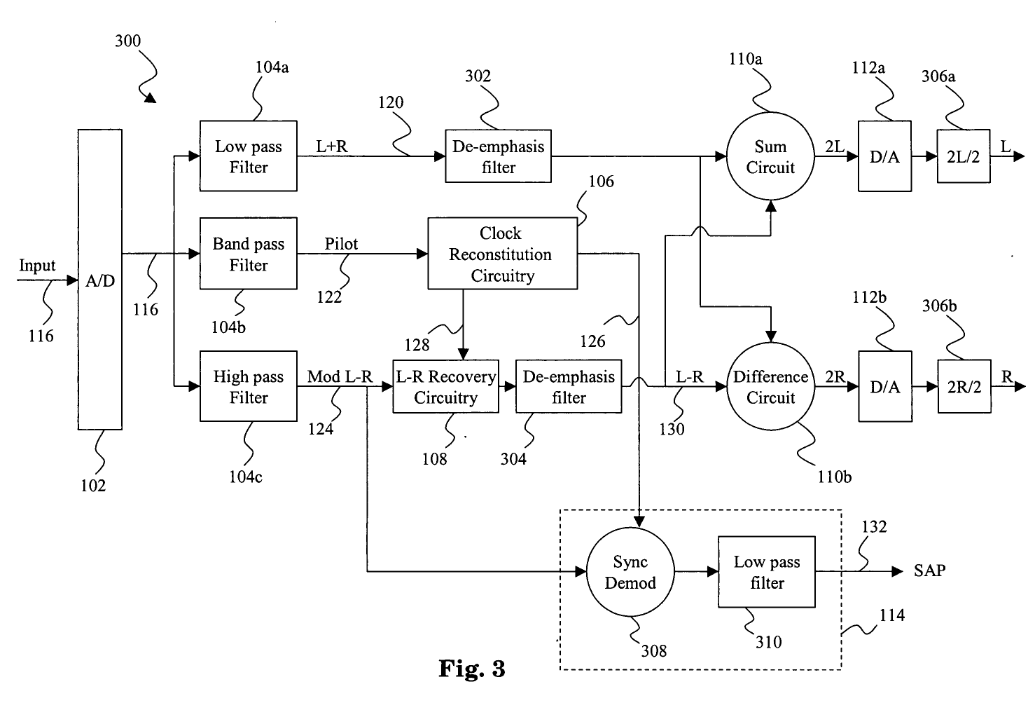

Referring now to FIGS. 3-5, in another embodiment, a digital decoding system 300 may be used to digitally demodulate the analog signal 200 of FIG. 2 and recover the encoded L and R channels from the L+R signal 202 and the L−R signal 206, as well as additional information such as the SAP signal 210. In the present example, the system 300 illustrates a more detailed example of the system 100 of FIG. 1. The system 300 includes an analog to digital (A/D) converter 102, multiple digital filters 104a-104c, clock reconstitution circuitry 106, L−R signal recovery circuitry 108, L/R channel recovery circuitry including sum circuitry 110a and difference circuitry 110b, D/A converters 112a and 112b, additional signal recovery circuitry 114 (which is for recovering a SAP signal in the present example), de-emphasis filters 302, 304, and attenuators 306a, 306b. These components form an L+R signal path for recovering the L+R signal, an L−R signal path for recovering the L−R signal, and a clock reconstitution path for recovering a clock signal. Although the output of each of these signal paths may be unique, there may be some interconnection between the paths.

The A/D converter 102 is a relatively high speed interpolating A/D converter able to sample the analog signal 200 and supply the samples to filters 104a-104c. An exemplary output sample frequency may be 375 kHz or two times the sample frequency used in the modulator that encoded the signal. This may provide adequate over-sampling of the SAP signal 210, while being low enough to allow reasonable filter sizes on the input. The nature of this interpolating filter also eases the input filter requirements since alias terms are far removed.

In the present example, the filters are finite impulse response (FIR) filters and include a low pass filter 104a, a band pass filter 104b, and a high pass filter 104c. The low pass filter 104a allows the L+R signal 202 from the analog signal 200 to pass without introducing group delay distortion, while removing the other components of the analog signal 200. In the present example, the low pass filter 104a has a cut-off frequency of 13.8 kHz with more than 60 dB rejection of the closest spectral component, which is 15.734 kHz (e.g., the pilot signal 204). The band pass filter 104b is centered at 15.734 kHz (e.g., the pilot signal 204) and is used as the input to the clock reconstitution circuitry 106. The high pass filter 104c is used to remove the lower frequency components (e.g., those falling within the ranges of the low pass and band pass filters 104a, 104b) of the analog signal 200 and limit the input to two synchronous demodulators associated with the L−R signal recovery circuitry 108 and the SAP recovery circuitry 114.

The de-emphasis filter 302 is an infinite input response (IIR) filter designed to simulate a Bi-Quadratic function. This de-emphasizes an emphasis placed on the signal during modulation. The output of the de-emphasis filter 302 is directed into the L/R channel recovery circuitry 110a, 110b. In some embodiments, the de-emphasis filter 302 may be implemented elsewhere, such as within the low pass filter 104a.

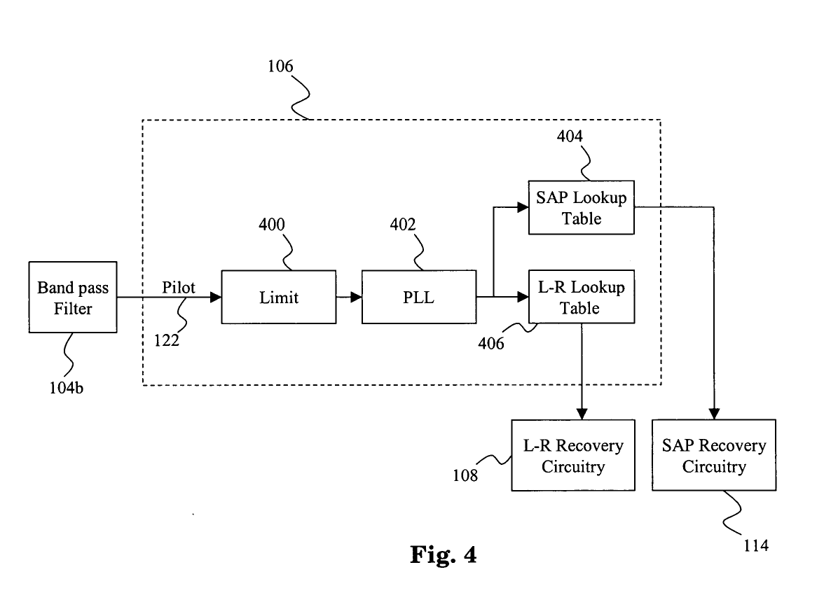

With additional reference to FIG. 4, clock reconstitution circuitry 106 is illustrated with a limiter 400, a phase-locked loop (PLL) 402, and look-up tables 404, 406. As described previously, the analog signal 200 contains a reference carrier (e.g., the pilot signal 204) that may be used to demodulate the L−R and SAP signals 206, 210, respectively. FCC specifications require reconstructed clocks to maintain accuracy to +−4 degrees. Classical implementations introduce delay distortions and jitter that must be reduced by compensation. The nature of the digital filters used in the present embodiment coupled with a digital PLL satisfy the accuracy requirements while minimizing or completely eliminating amplitude variation.

The limiter 400 conditions the pilot signal 204 received from the band pass filter 104b for comparison against a reference signal within the PLL 402. More specifically, the limiter 400 reduces the amplitude of the pilot signal 204 if the pilot signal is higher than a predefined threshold and increases the amplitude of the pilot signal if the pilot signal is below a predefined threshold. The conditioned pilot signal is then passed to the PLL 402.

The PLL 402 is a digital phase-locked loop that comprises a feedback system for controlling the phase of a digitally generated oscillator. In the present example, the PLL 402 includes a digital phase accumulator and a second order accumulator (not shown). The digital phase accumulator may be clocked at a relatively high rate (e.g., 24 MHz) to form an oscillator.

In operation, the PLL 402 samples the incoming pilot signal at 24 MHz and digitally generates a value. The generated value is then compared to a lookup table and correction is applied if needed. This process may be accomplished by adding a number to the accumulator at each clock cycle in the correct amount such that the accumulator overflows at the reference carrier rate of 15.734 KHz. To adjust the phase to maintain phase lock, the added number is changed slightly based on the phase difference between the output of the digital phase accumulator and the input reference. An additional benefit of this type of oscillator is that the output of the accumulator represents the phase of the signal at any point in time. This phase information is used to address the lookup tables 404, 406 so that a very accurate reference signal can be generated for the L−R signal recovery circuitry 108 and the additional signal recovery circuitry 114. By selecting various tap positions of the accumulator, multiples of the reference frequency can be generated. Additionally, the second order accumulator may be used to allow the phase error to approach zero even with static frequency errors in local clocks.

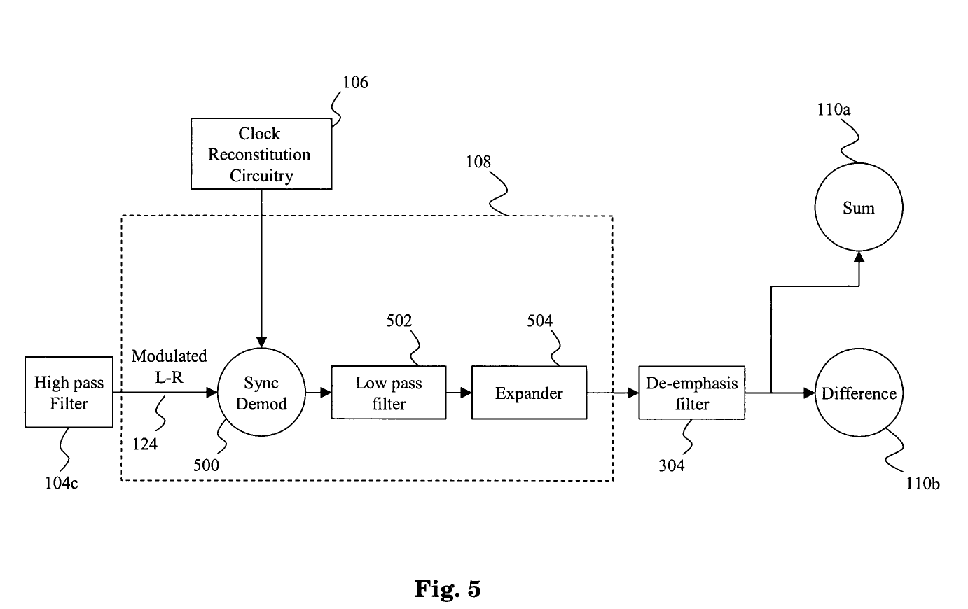

With additional reference to FIG. 5, the L−R signal recovery circuitry 108 includes a synchronous demodulator 500, a low pass filter 502, and a expander 504. The synchronous demodulator 500 uses input from the L−R lookup table 406 of the clock reconstitution circuitry 106 to demodulate the L−R signal. The demodulated signal is then passed through the low pass filter 502 and into the expander 504. The low pass filter 502 eliminates extraneous information from the signal, such as the SAP signal. The expander reverses companding that occurred during modulation of the signal 200 to restore the original amplitude and phase characteristics of the L−R signal. In the present example, the expander utilizes a digital implementation of a root mean square (RMS) detector (not shown) for accurate and repeatable results. The RMS detector output may be used as input to lookup tables (not shown) to identify filter coefficients needed for adjusting the gain and phase of the L−R signal. The recovered L−R signal is then passed into the de-emphasis filter 304.

In the present example, the de-emphasis filter 304 is an IIR filter designed to simulate a bi-quadratic function. This de-emphasizes an emphasis placed on the signal during modulation. The output of the de-emphasis filter 304 is directed into the L/R channel recovery circuitry represented by 110a, 110b. In some embodiments, the de-emphasis filter may be implemented elsewhere, such as within the L−R signal recovery circuitry 108.

The L+R signal and the recovered L−R signal are passed into the LIR channel recovery circuitry to convert L+R and L−R to L and R. In the present example, this is accomplished by subtracting and adding the L+R and L−R signals using the difference circuitry 110b and sum circuitry 110a. This produces 2R and −2L, respectively, which is readily inverted to 2L. The 2R and 2L signals are passed through D/A converters 112a, 112b. If needed, each signal may be scaled to R and L using attenuators 306a, 306b.

Referring again to FIG. 3, the SAP recovery circuitry 114 may include a synchronous demodulator 308 and a low pass filter 310. The synchronous demodulator 308 uses input from the SAP lookup table 404 of the clock reconstitution circuitry 106 to demodulate the SAP signal. The low pass filter 310 removes extraneous information from the signal before it is passed out of the SAP recovery circuitry 114.

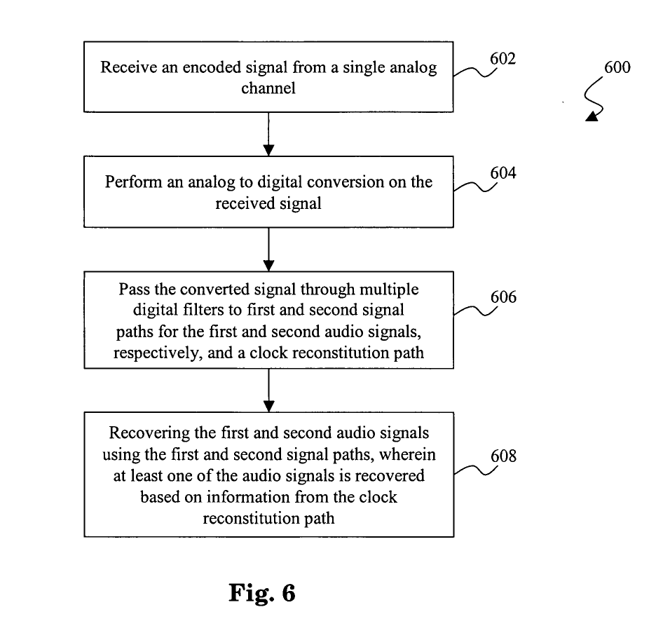

Referring now to FIG. 6, a method 600 illustrates the operation of the system 300 of FIG. 3. In step 602, an encoded signal is received from a single analog channel. An analog to digital conversion is performed on the received signal in step 604 and, in step 606, the converted signal is passed through multiple digital filters forming first and second signal paths for the first and second audio signals, respectively, and a clock reconstitution path. The first and second audio signals are then recovered in step 608 using the first and second signal paths, where at least one of the audio signals is recovered based on information from the clock reconstitution path.

Accordingly, a digital decoder system may be used to decode Broadcast Television Systems Committee (BTSC) encoded audio programs. In addition to stereo, circuitry may also be included to allow decoding of SAP signals. In some embodiments, the system may include digital processing; the use of FIR digital filters to minimize or eliminate group delay equalizers; the use of an interpolating input A/D converter with high sample rates to reduce analog filter requirements; decimating output D/A conversions with high sample rates to eliminate output analog filters; the use of a digital second order PLL to recover the pilot carrier with relatively no phase error; the elimination of adjustments needed for even moderate clock errors; the use of a phase accumulator clock generator driven by the PLL to eliminate AM distortion in the synchronous demodulation; and the use of a table driven expander utilizing digital RMS detectors to eliminate the need for compensation circuitry.

The design of the present disclosure realizes a low cost digital architecture able to produce high quality audio output. The use of FIR filters allows the design to have a wide frequency response without the introduction of group delay distortion. The slight increase in complexity due to these filters is more than offset by the elimination of imprecise compensation networks. Further use of digital RMS detectors and expander functions add to the precision of this architecture.

While the disclosure has been shown and described with reference to particular embodiments thereof, it will be understood by those skilled in the art that various changes in form and detail may be made without departing from the scope and spirit of the disclosure. For example, while the system 300 is illustrated with SAP recovery circuitry, it is understood that the other signal types may be recovered instead of, or in addition to, the SAP signal. Furthermore, the filters may be arranged in a cascading manner, rather than in the parallel arrangement illustrated and described. In addition, it is understood that the L+R channel may be recovered in a manner similar to that described for the L−R single, although this may entail the use of an inverter to swap the L and R channels before output occurs. Furthermore, functionality illustrated in circuitry or in a signal path may be moved to other circuitry or another signal path. For example, the lookup table illustrated in the clock reconstitution path and used for L−R recovery may be positioned within the L−R recovery circuitry itself. Functionality may also be changed as needed. For example, the attenuators may instead be replaced with amplifiers to amplify, rather than attenuate, the resulting signals. Similarly, the position of certain components relative to other components may be altered. For example, the positions of the D/A converter and the attenuators may be reversed. Also, in some embodiments, the expander may be a part of a compander. Therefore, it is understood that several modifications, changes, or substitutions are intended in the foregoing disclosure and in some instances, some features of the disclosure may be employed without a corresponding use of other features. Accordingly it is appropriate that the following claims be construed broadly and in a manner consistent with the scope of the disclosure.

What is claimed is:

1. A digital decoding system for demodulating a modulated analog signal containing a L+R signal, a L−R signal centered around a carrier signal, and a pilot signal, the system comprising:
an analog to digital converter adapted to convert the analog signal into a digital signal;
first, second, and third digital filters adapted to separate the L+R signal, the pilot signal, and the L−R signal, respectively, from the digital signal;
clock reconstitution circuitry adapted to reconstitute a clock signal from the pilot signal;
L−R signal recovery circuitry adapted to recover the L−R signal using the reconstituted clock signal; and
channel recovery circuitry adapted to recover a left channel signal and a right channel signal from the L+R signal and the L−R signal.

2. The digital decoding system of claim 1 wherein the first digital filter is a low pass filter, the second digital filter is a bandpass filter, and the third digital filter is a high pass filter.

3. The digital decoding system of claim 2 wherein the low pass filter has a cut-off frequency of approximately 13.8 kHz, the band pass filter is centered at approximately 15.734 kHz, and the high pass filter is adapted to remove frequencies that pass through the low pass and band pass filters.

4. The digital decoding system of claim 2 further comprising additional signal recovery circuitry including a demodulator adapted to receive input from the clock reconstitution circuitry and the high pass filter, wherein the additional signal recovery circuitry is adapted to recover a signal other than the L+R signal, L−R signal, and pilot signal from the modulated analog signal.

5. The digital decoding system of claim 4 wherein the additional signal is a second audio program (SAP) signal.

6. The digital decoding system of claim 2 wherein the L−R signal recovery circuitry includes:
a synchronous demodulator adapted to demodulate the L−R signal received from the high pass filter using clock information from the clock reconstitution circuitry; and
an expander for expanding the demodulated L−R signal.

7. The digital decoding system of claim 1 wherein the clock reconstitution circuitry comprises a phase-locked loop (PLL) associated with at least one lookup table.

8. The digital decoding system of claim 7 wherein an output of the PLL represents a phase of the pilot signal, and wherein the output is used to address the lookup table to generate a sine wave for the L−R signal recovery circuitry.

9. The digital decoding system of claim 7 wherein the PLL comprises a digital phase accumulator and a second order accumulator.

10. The digital decoding system of claim 7 wherein the PLL includes a sample rate of approximately 24 MHz.

11. The digital decoding system of claim 1 wherein the channel recovery circuitry is adapted to calculate a sum and a difference of the L+R signal and the L−R signal.

12. The digital decoding system of claim 1 further comprising a digital to analog converter adapted to convert the recovered left channel and right channel signals from digital signals into analog signals.

13. A demodulator for digitally demodulating a received analog signal including having a pilot signal, a L+R signal, and a L−R signal, the demodulator comprising:
an analog to digital converter for converting the received analog signal to a digital signal;
a plurality of filters for separating the pilot signal, L+R signal, and L−R signal into a clock reconstitution path, a L+R signal path, and a L−R signal path, respectively;
circuitry within the clock reconstitution path for reconstituting a clock signal from the pilot signal;
circuitry within at least one of the L+R and L−R signal paths for recovering at least one of the L+R or L−R signals using the reconstituted clock signal; and
circuitry for recovering a Left signal and a Right signal from the L+R signal path and the L−R signal path.

14. The demodulator of claim 13 wherein the circuitry for recovering the Left and Right signals includes a demultiplexing matrix.

15. The demodulator of claim 13 wherein the circuitry within the clock reconstitution path includes a phase-locked loop (PLL) associated with at least a first lookup table, wherein the PLL is adapted to generate a digital value that is compared to a plurality of digital values in the first lookup table for use in at least one of the L+R and L−R signal paths.

16. The demodulator of claim 15 further comprising additional signal recovery circuitry adapted to recover a signal other than the L+R signal, L−R signal, and pilot signal.

17. The demodulator of claim 16 wherein the circuitry within the clock reconstitution path includes a second lookup table for use with the additional signal recovery circuitry.

18. A method for digitally decoding an encoded signal, the method comprising:
receiving an encoded signal from a single analog channel, wherein the encoded signal includes at least first and second audio signals;
performing an analog to digital conversion on the received signal;
separating the converted signal using multiple digital filters into first and second signal paths for the first and second audio signals, respectively, and a clock reconstitution path; and
recovering the first and second audio signals using the first and second signal paths, respectively, wherein at least one of the first and second audio signals is recovered based on information from the clock reconstitution path.

19. The method of claim 18 further comprising performing a digital to analog conversion on the two recovered audio signals.

20. The method of claim 18 wherein recovering at least one of the first and second audio signals includes reconstituting clock information carried within the received signal.
